(19) United States
(12) Patent Application Publication
(10) Pub. No.: US 2007/0076409 A1
(43) Pub. Date: Apr. 5, 2007

(54) DURABLE ILLUMINATED STITCHING TOOLS CONFIGURED TO PROVIDE AMBIENT LIGHTING AND AN ILLUMINATED WORKING TIP

(75) Inventors: William A. Boesch, Ripon, WI (US); Michael J. Zambrowicz, Ripon, WI (US); Roger O. Gundlach, Ripon, WI (US)

Correspondence Address: MARK YOUNG, P.A., 12086 FORT CAROLINE ROAD, UNIT 202, JACKSONVILLE, FL, 32225, US

(73) Assignee: MR B INNOVATIONS, INC., Ripon, WI (US)

(21) Appl. No.: 11/469,616

(22) Filed: Sep. 1, 2006

Related U.S. Application Data
(60) Provisional application No. 60/719,096, filed on Sep. 22, 2005.

(51) Int. Cl. F21V 33/00

(52) U.S. Cl. 362/109

(57) ABSTRACT

An illuminated stitching tool includes a handle, a controllable light source coupled to the handle, and a light transmitting shaft operably coupled to the handle at a proximal end and in optical communication with the light source. The light transmitting shaft is elongated, has a free working end and is adapted to emit light radially and at the free working end. The free working end may comprise a tapered end culminating with a point adapted for knitting, or a hooked end with a thread guide adapted for crocheting. The handle may include an interior compartment configured to house the light source. The light transmitting shaft is solid, substantially rigid and transparent. A frosted finish (e.g., an abraded surface treatment) provided on the outer surface of the shaft enables emission of diffuse light radially outward equally along the shaft.

### RELATED APPLICATION

This application claims the benefit of priority of U.S. Provisional Application 60/719,096, filed Sep. 22, 2005, the entire contents of which are incorporated herein.

### FIELD OF THE INVENTION

This invention generally relates to knitting and crocheting, and more particularly, to durable knitting needles and crocheting hooks with diffusely illuminated shafts and brightly illuminated working ends.

### BACKGROUND

Crocheting and knitting are popular stitching crafts practiced by hobbyists and professionals worldwide. Each activity requires an understanding of the processes, hand-eye coordination and visibility of the working end as well as surrounding areas. A user must be able to form, manipulate and see knots and loops at the free end, i.e., working end, of the corresponding stitching tool, such as a knitting needle or crocheting hook.

Crocheting generally entails placing a slip-knot loop on a hook, pulling another loop through the first loop, and so on to create a chain. The chain is either turned and worked in rows, or joined end-to-end and worked in rounds. Rounds can also be created by working many stitches into a single loop. Stitches are made by pulling one or more loops through each loop of the chain. Effective crocheting requires visibility of loops, chains, rows and rounds.

A crochet hook is a type of needle, with a hook at one end, used to draw thread through knotted loops. Only one crochet hook is needed to make crochet stitches. The hooks come in various sizes (measured in millimetres or fractions of an inch), according to the thickness of the needle. The size of the hook is usually matched with an appropriate ply or thickness of thread. While conventional crochet hooks are effective for forming crochet stitches, they do not enhance visibility of the working end or surrounding areas.

Similar to crocheting, knitting entails pulling bights through other bights. Hand knitted fabrics are usually begun by forming a base series of twisted loops of yarn on a knitting needle (“cast on”). To form a new stitch, a second knitting needle is used to reach through each loop (or stitch) in succession to pull a bight of yarn back through the loop. Work can proceed in the round (circular knitting) or by going back and forth in rows (flat knitting). As with crocheting, effective knitting demands visibility of loops, bights, rows and rounds.

A knitting needle is an elongated rod with a pointed end used as a tool in the manufacture of hand knitted fabric. The needle is used to reach through a knitting stitch in order to snag a bight of yarn and pull a length back through the stitch to form a new loop at the top of the current row of stitches. The simplest requirements of knitting needles are that they must be smooth, thin and long enough to reach through a stitch and strong enough not to break while manipulating the bight of yarn. Knitting needles, commonly used in pairs, are the only essential tools for hand knitting. While conventional knitting needles are effective for forming knit stitches, they too do not enhance visibility of the working end or surrounding areas.

To enhance visibility at the working ends, illuminated stitching tools have been devised. By way of example, U.S. Pat. No. 2,344,370 discloses an illuminated knitting needle with a removable Lucite needle adapted for transmitting light from a light source within a handle only to the tip of the needle. Likewise, U.S. Pat. No. 6,325,522 discloses a hand held illuminated device with interchangeable implements, including crochet hooks and knitting needles. Light is directed onto a workpiece concentrically from a window in a handle.

While the prior art devices improve visibility in poorly lit conditions, they have shortcomings. In particular, they direct light to the working end. Little or no additional ambient lighting is provided. Thus, rows and rounds may be difficult to see in poorly lit conditions, even though a loop at the working end of the implement may be illuminated and visible. Users of such devices cannot count their finished stitches as they progress in dimly lit conditions.

Other shortcomings of these prior art devices include excessive heat, susceptibility to shock and excessive power consumption. The prior art devices feature incandescent lamps to generate light. Such light sources give off substantial heat. They are hypersensitive to shocks and vibrations, with heated filaments that tend to break easily. They also consume substantial electrical energy (most of which produces wasted heat). Additionally, they have relatively short life spans and fail by dimming over time, rendering them ineffective during the waning stages of their life.

Accordingly, a need exists for a stitching tool with a working end and shaft configured to conveniently emit light. The tool should also be shock resistant, cool, long lasting, relatively efficient and lightweight. The invention is directed to overcoming one or more of the problems and solving one or more of the needs as set forth above.

### SUMMARY OF THE INVENTION

An exemplary illuminated stitching tool according to principles of the invention includes a handle, a controllable light source coupled to the handle, and a light transmitting shaft operably coupled to the handle at a proximal end and in optical communication with the light source. The light transmitting shaft is elongated, has a free working end and is adapted to emit light radially and at the free working end. The free working end may comprise a tapered end culminating with a point adapted for knitting, or a hooked end with a thread guide adapted for crocheting. The handle may include an interior compartment configured to house the light source.

The light source comprises a power supply, a light emitting diode and a switch. The switch is operably coupled between the light source and power supply and configured to control activation and deactivation of the light source. The power supply is configured to provide electrical power to activate the light. The power supply may be comprised of at one or more disposable or rechargeable batteries.

An electronics housing may be releasably or permanently attached to the handle, configured to contain the light source, and adapted to direct light from the light source to the light transmitting shaft.

The light transmitting shaft is solid, substantially rigid and transparent (or translucent). It may be comprised of glass, polycarbonate, acrylic, polymethyl methacrylate, polysulphone, polyester, or styrene acrylonitrile. A frosted finish (e.g., an abraded surface treatment) may be provided on the outer surface of the shaft to emit diffuse light radially outward equally along the shaft.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a perspective view of an exemplary durable illuminated knitting needle configured to provide ambient lighting and an illuminated working tip in accordance with principles of the invention;

FIG. 2 is an exploded view of an exemplary durable illuminated knitting needle configured to provide ambient lighting and an illuminated working tip in accordance with principles of the invention;

FIG. 3 is a plan view of an exemplary durable illuminated knitting needle configured to provide ambient lighting and an illuminated working tip in accordance with principles of the invention;

FIG. 4 is a perspective view of an exemplary durable illuminated crocheting hook configured to provide ambient lighting and an illuminated working tip in accordance with principles of the invention;

FIG. 5 is an exploded view of an exemplary durable illuminated crocheting hook configured to provide ambient lighting and an illuminated working tip in accordance with principles of the invention;

FIG. 6 is a plan view of an exemplary durable illuminated crocheting hook configured to provide ambient lighting and an illuminated working tip in accordance with principles of the invention; and

FIG. 7 is a circuit diagram that conceptually illustrates components of an exemplary circuit for a light emitting diode (LED) light source in accordance with the principles of the invention.

Those skilled in the art will appreciate that the invention is not limited to the exemplary embodiments depicted in the figures or the shapes, relative sizes, proportions or materials shown in the figures.

### DETAILED DESCRIPTION

With reference to the drawings, wherein like numerals represent like features, perspective, exploded and plan views of an exemplary knitting needle and crocheting hook in accordance with principles of the invention are conceptually shown. For convenience of reference, the exemplary device (e.g., knitting needle and/or crocheting hook) may be referred to herein as a stitching tool.

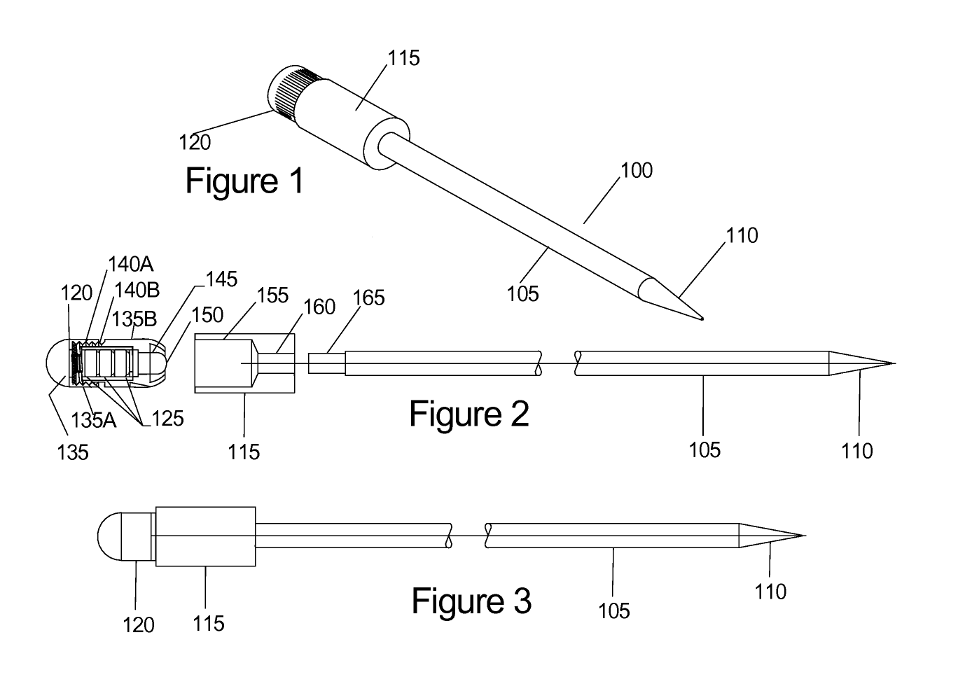

Referring to FIGS. 1 through 3, perspective, exploded and plan views of an exemplary durable illuminated knitting needle 100 configured to provide ambient lighting and an illuminated working tip in accordance with principles of the invention are shown. The exemplary knitting needle 100 is comprised of an elongated shaft 105 with a tapered end 110 culminating with a point, and a handle 115 opposite to the tapered end 110. The handle 115 includes an interior compartment 155 configured to house a controllably activated light source 150 and power supply 125. The free end 135 of the handle 115 includes a switch 120 for activating and deactivating the light source 150 within the handle 115.

In a preferred implementation, the free end 135 of the handle comprises a module, which is also referred to herein as an electronics housing. The electronics housing 135 comprises a container for electronic components, such as a power supply 125, a switch 120 and a light source 150, and is removable from the handle 115. A distal portion 135B of the electronics housing 135 may be mechanically (e.g., threadedly or frictionally) releasably or permanently secured in a corresponding compartment 155 of the handle 115. The electronics housing 135 may thus be removed for disposal and replacement, or for repair.

The switch 120 is operably coupled between the light source 150 and power supply 125 and configured to control activation and deactivation of the light source 150. The switch 120 may be a rotary, toggle, push button or any other mechanical, electrical or electromechanical switch suitable for user activation and deactivation.

The power supply 125 provides electrical power required to activate the light source 150 when the switch is activated. The power supply 125 may be comprised of one or more disposable or rechargeable batteries, or photo-voltaic cells with one or more rechargeable batteries, are provided in a battery compartment in the electronics housing 135. In the latter case, the photovoltaic cells may charge the batteries when ambient light is available. The photovoltaic cells may also serve as a photo-sensor, in which case they may recharge the power supply during well illuminated conditions and allow activation of the light source when the background light is dim.

A light source 150, such as a light emitting diode (LED), is provided for illumination. The LED 150 emits visible light when a current passes through it in the correct direction. The color, size, shape, and viewing angle of the LED may be selected to achieve satisfactory visibility in a compact, lightweight, energy efficient design. A miniature (e.g., 5 mm round cross-section) or subminiature (e.g., 3 mm round cross section) LED with a 30° or 60° viewing angle may be utilized. A lens 145, transparent cover or aperture may be provided to promote and/or enable transmission of light from the light source 150 to the elongated shaft 105.

The electronics housing 135 may include separable portions, i.e., such as a proximal portion 135A and a distal portion 135B, to provide access to housed components (i.e., the power supply 125, switch 120 and light source 150). By way of example and not limitation, the distal portion 135B may be equipped with male threads 140B adapted to mate with a proximal portion 135A having female threads 140A. Separation of the distal portion 135B from the proximal portion 135A reveals the electronic components housed therein. Worn and consumed components (e.g., expended disposable batteries) may then be readily replaced.

A channel 160 is provided in the handle for receiving the handle end (i.e., proximal end) 165 of the elongated shaft 105. The proximal end 165 may be mechanically (e.g., threadedly or frictionally) releasably or permanently secured in the channel 160. Light from the light source 150 may pass through the interior compartment 155, and through the channel 160 to the proximal end 165 for transmission through the elongated shaft 105.

The elongated shaft 105 with the tapered end 110 is configured to function as a knitting needle. Illustratively, in use, the elongated shaft 105 with the tapered end 110 culminating with a point is used to reach through a knitting stitch in order to snag a bight of yarn and pull a length back through the stitch to form a new loop at the top of a current wale of stitches. The handle 115 prevents stitches from falling off the needle 100.

In addition to serving as a knitting needle, the elongated shaft 105 with the tapered end 110 functions as a light transfer medium, i.e., a physical medium which may transmit light from one end to the other by optically guiding light along its length. By way of example, but not limitation, the elongated shaft 105 may have a solid core with a round, oval, elliptical or other cross-sectional shape. The elongated shaft 105 may be composed of translucent, highly transparent (or translucent) material through which light may pass without appreciable transmission losses. Illustratively, the elongated shaft 105 may be composed of glass, polycarbonate or acrylic as well as many other materials. The light transfer medium is preferably substantially rigid. In a particular preferred implementation, the elongated shaft 105 may be comprised of Lexan®, General Electric Company's brand of highly-durable polycarbonate resin thermoplastic. Other transparent (or translucent) materials suitable for transmitting light, such as polymethyl methacrylate (Plexiglas/Lucite/Perspex), polysulphone, polyester, styrene acrylonitrile (SAN), poly-4-methyl-1-pentene, polyamide, polyurethane type resins and glass may be utilized in lieu of polycarbonate resin thermoplastic. However, in the broad context of the present invention, it can be appreciated that other transparent or translucent type plastic materials that transmit light as described herein come within the scope of the invention.

A frosted finish is formed on the outer surface of the shaft 105 to transmit diffuse light radially outward along the length of the shaft 105. In particular, the outer surface of the shaft 105 is made slightly dull (i.e., frosted) to emit diffuse light radially along the length of the shaft 105 (i.e., provide ambient lighting). The frosted finish emits lights equally along the entire shaft length. As used herein, frosted finish refers to any finish that causes the shaft 105 to diffusely emit transmitted light radially along the length of the shaft. As used herein, ambient light refers to general surrounding light that illuminates areas in proximity to the tool and softens contrasts between the illuminated working tip and surrounding areas.

An exemplary process for achieving a frosted finish entails abrasion. By way of example and not limitation, the ends of the shaft may be chucked in an arbor and rotated (e.g., at 400 rpm). An abrasive material such as new 1500 grit waterproof sandpaper may be applied to the surface of the rotating shaft to achieve a frosted finish. The sandpaper may be about one-inch (1″) wide and wrapped 180 degrees around the shaft. The sandpaper may be held under tension (e.g., approximately 1 psi) against the shaft. The sandpaper may rub against the tapered end move slowly along the entire surface of the shaft. Care should be taken not to dwell in one spot or heating will occur and the plastic will melt. The frosting process rubs the surface in one pass moving at a rate of approximately one inch (1″) per second from one end to the opposite end and back to originating end. Extra passes or dwell may produce excessive frosting, which yields dim illumination of the tapered end. Under-frosting (i.e., insufficient frosting) provides bright illumination of the tapered end, but only dim lighting along the length of the shaft. The exemplary frosting process produces lighting comparable to the light emitted from a fluorescent light bulb. A properly frosted shaft emits a soft glow at the tapered end and uniform illumination along the length of the shaft.

Other surface treatment methods to evenly attenuate, soften or diffuse light emitted along the length of the shaft may be utilized. Such other methods may entail processes for grinding and/or roughening the surface, such as sandblasting; or processes for coating the surface with a film or other material designed to diffuse the light; or processes for altering the composition of the shaft at or near the surface to affect the optical properties; or any other method that provides a uniform frosted finish.

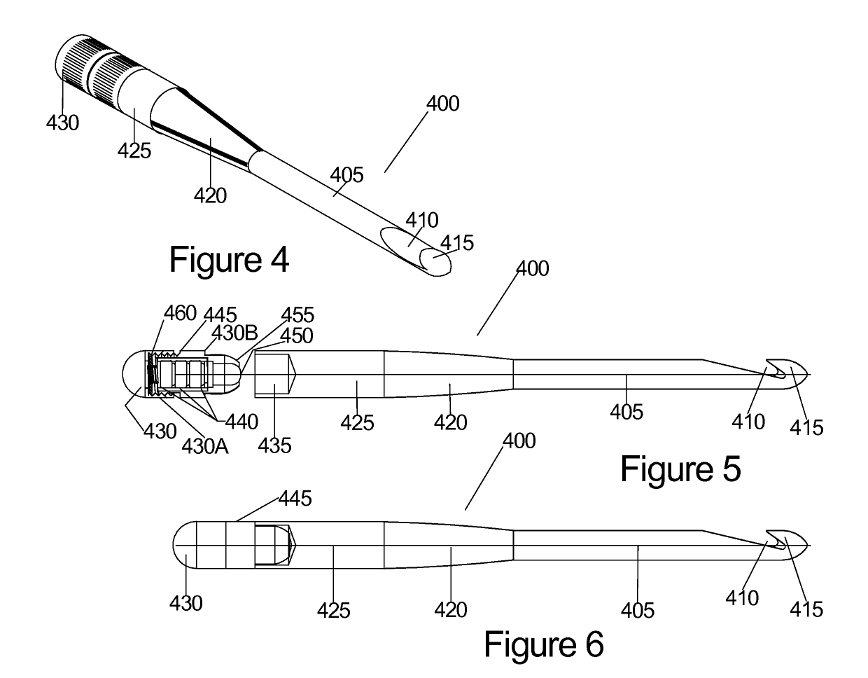

Referring to FIGS. 4 through 6, perspective, exploded and plan views of an exemplary durable illuminated crocheting hook 400 configured to provide ambient lighting and an illuminated working tip in accordance with principles of the invention are shown. The exemplary crocheting hook 400 is comprised of an elongated shaft 405 with a conventional hooked head 415 providing a thread guide 410. A handle 425 is provided opposite the head 415. The handle 425 includes an interior compartment configured to house a controllably activated light source 455 and power supply 440. The free end 430 of the handle 425 includes a switch 460 for activating and deactivating the light source 455 within the handle 425.

In a preferred implementation, the free end 430 of the handle 425 comprises a module, which is also referred to herein as an electronics housing. The electronics housing 430 comprises a container for electronic components, such as a power supply 440, a switch 460 and a light source 455, and is removable from the handle 425. A distal portion 430B of the electronics housing 430 may be mechanically (e.g., threadedly or frictionally) releasably or permanently secured in a corresponding compartment 435 of the handle 425. The electronics housing 430 may thus be removed for disposal and replacement, or for repair.

The switch 460 is operably coupled between the light source 455 and power supply 440 and configured to control activation and deactivation of the light source 455. The switch 460 may be a rotary, toggle, push button or any other mechanical, electrical or electromechanical switch suitable for user activation and deactivation.

The power supply 440 provides electrical power required to activate the light source 455 when the switch is activated. The power supply 440 may be comprised of one or more disposable or rechargeable batteries, or photo-voltaic cells with one or more rechargeable batteries, are provided in a battery compartment in the electronics housing 430. In the latter case, the photovoltaic cells may charge the batteries when ambient light is available. The photovoltaic cells may also serve as a photo-sensor, in which case they may recharge the power supply during well illuminated conditions and allow activation of the light source when the background light is dim.

A light source 455, such as a light emitting diode (LED), is provided for illumination. The LED 450 emits visible light when a current passes through it in the correct direction. The color, size, shape, and viewing angle of the LED may be selected to achieve satisfactory visibility in a compact, lightweight, energy efficient design. A miniature (e.g., 5 mm round cross-section) or subminiature (e.g., 3 mm round cross section) LED with a 30° or 60° viewing angle may be utilized. A lens 455, transparent cover or aperture may be provided to promote and/or enable transmission of light from the light source 455, through the compartment, through the handle 425, through the coupling 420 and to the elongated shaft 405.

The handle 425 and coupling 420 are configured to facilitate transmission of light. For example, the handle and/or coupling may be comprised of the same material or a similar transparent material as the shaft 405. Alternatively, the handle and/or coupling may include a hollow core, or a core comprised of the same material or a similar transparent material as the shaft 405. Various lenses may be incorporated into the handle and/or coupling to focus or diffuse transmitted light.

Optionally, the electronics housing 430 may include separable portions, i.e., such as a proximal portion 430A and a distal portion 430B, to provide access to housed components (i.e., the power supply 440, switch 460 and light source 455). By way of example and not limitation, the distal portion 430B may be equipped with threads 445 adapted to mate with a correspondingly threaded proximal portion 430A. Separation of the distal portion 430B from the proximal portion 430A reveals the electronic components housed therein. Worn and consumed components (e.g., expended disposable batteries) may then be readily replaced.

A tapered coupling 420 is attached to the handle 425 for receiving the adjoining the elongated shaft 405 to the handle 425. The coupling 420 may be mechanically (e.g., threadedly or frictionally) releasably or permanently secured to the handle 425 and shaft 405. Light from the light source 455 may pass through the handle 425, the coupling 420 and the elongated shaft 405.

The elongated shaft 405 with the hooked end 415 and thread guide 410 is configured to function as a crocheting hook. Illustratively, in use, slip knots and chain stitches are formed on the crochet hook. Yarn may be brought over the hook, grabbed with the hook and drawn through a slip knot to makes a chain stitch. The sequence may be repeated to create rows of chain stitches in a manner familiar to those skilled in the art of crocheting. The handle 425 prevents stitches from falling off the shaft 405.

In addition to serving as a crocheting hook, the elongated shaft 405 with the hooked end 415 and thread guide 410 functions as a light transfer medium, i.e., a physical medium which may transmit light from one end to the other by optically guiding light along its length. By way of example, but not limitation, the elongated shaft 405 may have a solid core with a round, oval, elliptical or other cross-sectional shape. The elongated shaft 405 may be composed of translucent, highly transparent material through which light may pass without appreciable transmission losses. By way of example and not limitation, the elongated shaft 405 may be composed of glass, polycarbonate or acrylic as well as many other materials. The light transfer medium is preferably substantially rigid. In a particular preferred implementation, the elongated shaft 405 may be comprised of Lexan®, General Electric Company's brand of highly-durable polycarbonate resin thermoplastic. Other transparent (or translucent) materials suitable for transmitting light, such as polymethyl methacrylate (Plexiglas/Lucite/Perspex), polysulphone, polyester, styrene acrylonitrile (SAN) and glass may be utilized in lieu of polycarbonate resin thermoplastic. However, in the broad context of the present invention, it can be appreciated that other transparent (or translucent) type plastic materials are suitable, provided they transmit light as described herein. Illustratively, other transparent plastic include, but are not limited to polyester, polysulphone, poly-4-methyl-1-pentene, polyamide, and polyurethane type resins.

The outer surface of the shaft 405 is adapted with a frosted finish to transmit light radially outward along the length of the shaft 405. In particular, the outer surface of the shaft 405 is made slightly dull (i.e., frosted) to emit diffuse light radially along the length of the shaft 405. The frosted finish emits lights equally along the entire shaft length.

A preferred process for achieving a frosted finish entails abrasion. By way of example and not limitation, the ends of the shaft may be chucked in an arbor and rotated (e.g., at 400 rpm). An abrasive material such as new 1500 grit waterproof sandpaper may be applied to the surface of the rotating shaft to achieve a frosted finish. The sandpaper may be about one-inch (1″) wide and wrapped 180 degrees around the shaft. The sandpaper may be held under tension (e.g., approximately 1 psi) against the shaft. The sandpaper may rub against the tapered end move slowly along the entire surface of the shaft. Care should be taken not to dwell in one spot or heating will occur and the plastic will melt. The frosting process rubs the surface in one pass moving at a rate of approximately one inch (1″) per second from the start to the opposite end and back to the tip. Extra passes or dwell may produce excessive frosting, which yields dim illumination of the tapered end. Under-frosting (i.e., insufficient frosting) provides bright illumination of the tapered end, but only dim lighting along the length of the shaft. The exemplary frosting process produces lighting comparable to the light emitted from a fluorescent light bulb. A properly frosted shaft emits a soft glow at the hooked end 415 and thread guide 410 and uniform illumination along the length of the shaft 405.

In an exemplary implementation, the thread guide 410 of the hooked end 415 also features a frosted surface comparable to the surface of the shaft 405. The frosted thread guide surface may be formed by machining, e.g., by sanding or grinding using a rotary burr or similar machining tool. Machine feed and the cutting tool tip may be adapted to provide an extremely fine threaded finish, comparable to a 125 micron surface and yielding illumination similar to the knitting needle.

Other surface treatment methods to evenly attenuate, soften or diffuse light emitted along the length of the shaft 405 and thread guide 410 may be utilized. Such other methods may entail processes for grinding and/or roughening the surface, such as sandblasting; or processes for coating the surface with a film or other material designed to diffuse the light; or processes for altering the composition of the shaft at or near the surface to affect the optical properties.

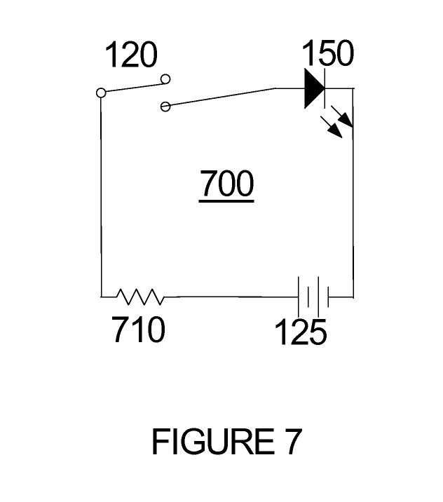

Referring now to FIG. 7, a circuit diagram that conceptually illustrates components of an exemplary circuit 700 for a light emitting diode (LED) light source 150 in accordance with the principles of the invention is shown. A light emitting diode (LED) 150 is provided as a source of visible light. The LED 150 emits visible light when a current passes through it in the correct direction. The color, size, shape, and viewing angle of the LED may be selected to achieve satisfactory visibility in a compact, lightweight, energy efficient design. A miniature (e.g., 5 mm round cross-section) or subminiature (e.g., 3 mm round cross section) LED with a 30° or 60° viewing angle may be utilized. Depending upon the power supply 125, a resistor 710 or other current limiter may optionally be provided in series to limit the current supplied to the LED 150 to a safe effective value.

A switch 120 is operably coupled to the LED 150 and configured to control the current supplied to the LED 150 from the power supply 125. In an exemplary embodiment, a switch 120 is provided, which allows current to flow to the LED 150 only when the switch is in an activated (e.g., on) position. The exemplary switch 120 may be manually adjusted to a deactivated (e.g., off) position to impede current flow.

A power supply 125 such as a battery is provided to supply electric power to the LED 150 when the switch 120 is activated. The battery 125 may be rechargeable or disposable, and removable or permanently installed. Illustratively, without limitation, a plurality of coin or button-style alkaline, silver-oxide or lithium-ion battery may be utilized to provide 4.5 or 6 volts.

Advantageously, the LED light source 150 is insensitive to vibration and shocks, unlike incandescent light sources. The LED light source 150 also provides an extremely long life span—typically ten years, twenty times longer than the best incandescent bulbs. Additionally, the LED light source 150 will typically fail by dimming over time, rather than an abrupt burn-out as with incandescent bulbs. Furthermore, the LED light source 150 gives off less heat and operates more efficiently than an incandescent light bulb with similar light output.

While an exemplary embodiment of the invention has been described, it should be apparent that modifications and variations thereto are possible, all of which fall within the true spirit and scope of the invention. With respect to the above description then, it is to be realized that the optimum relationships for the components of the invention and steps of the process, including variations in form, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. An illuminated stitching tool comprising a handle, a controllable light source coupled to said handle, a light transmitting shaft operably coupled to said handle at a proximal end and in optical communication with said light source, said light transmitting shaft being elongated, having a free working end and being adapted to emit light radially and at the free working end.

2. An illuminated stitching tool according to claim 1 wherein the free working end comprises a tapered end culminating with a point and adapted for knitting.

3. An illuminated stitching tool according to claim 1 wherein the free working end comprises a hooked end with a thread guide adapted for crocheting.

4. An illuminated stitching tool according to claim 1 wherein the handle includes an interior compartment configured to house the light source.

5. An illuminated stitching tool according to claim 1 wherein the light source comprises a power supply, a light emitting diode and a switch, said switch being operably coupled between the light source and power supply and configured to control activation and deactivation of the light source, and said power supply being configured to provide electrical power to activate the light.

6. An illuminated stitching tool according to claim 5 wherein the power supply is comprised of at least one disposable battery.

7. An illuminated stitching tool according to claim 5 wherein the power supply is comprised of at least one rechargeable battery.

8. An illuminated stitching tool according to claim 1 further comprising an electronics housing attached to the handle, configured to contain the light source, and adapted to direct light from the light source to the light transmitting shaft.

9. An illuminated stitching tool according to claim 8, said electronics housing being disposable.

10. An illuminated stitching tool according to claim 1, wherein the light transmitting shaft is solid, substantially rigid and transparent.

11. An illuminated stitching tool according to claim 10, wherein the light transmitting shaft is comprised of a material from the group consisting of glass, polycarbonate, acrylic, polymethyl methacrylate, polysulphone, polyester, and styrene acrylonitrile.

12. An illuminated stitching tool according to claim 11, wherein the light transmitting shaft includes a frosted finish on the outer surface.

13. An illuminated stitching tool according to claim 12, wherein the light transmitting shaft includes an outer surface with a frosted finish.

14. An illuminated stitching tool according to claim 13, wherein the light transmitting shaft is configured to emit light radially outward equally along the shaft.

15. An illuminated stitching tool according to claim 14, wherein the frosted finish comprises an abraded surface.

16. A method of forming an illuminated stitching tool comprising steps of providing a handle, operably coupling a controllable light source to said handle, operably coupling a light transmitting shaft coupled to said handle at a proximal end of the light transmitting shaft and in optical communication with said light source, said light transmitting shaft being elongated, having a free working end and being adapted to emit light radially and at the free working end.

17. A method of forming an illuminated stitching tool according to claim 16 further comprising a step of forming a frosted finish on an outer surface of the light transmitting shaft, said frosted finish being adapted to diffuse light transmitted radially outward along the length of the shaft.

18. A method of forming an illuminated stitching tool according to claim 17 wherein the step of forming a frosted finish includes rubbing the surface evenly against abrasive material.

19. An illuminated stitching tool comprising a handle, a controllable light source coupled to said handle, a light transmitting shaft operably coupled to said handle at a proximal end and in optical communication with said light source,
said light transmitting shaft being elongated, having a free working end and being adapted to emit light radially and at the free working end,
wherein the handle includes an interior compartment configured to house the light source, and the light source comprises a power supply, a light emitting diode and a switch, said switch being operably coupled between the light source and power supply and configured to control activation and deactivation of the light source, and said power supply being configured to provide electrical power to activate the light, and
the light transmitting shaft being solid, substantially rigid and transparent, and comprised of a material from the group consisting of glass, polycarbonate, acrylic, polymethyl methacrylate, polysulphone, polyester, and styrene acrylonitrile.

20. An illuminated stitching tool according to claim 19, wherein the light transmitting shaft includes an outer surface with a frosted finish configured to emit light radially outward equally along the shaft.
